(19) United States
(12) Patent Application Publication
(10) Pub. No.: US 2014/0080456 A1
(43) Pub. Date: Mar. 20, 2014

(54) Digital yearbook page-DYP

(71) Applicants: Robert Wayne Nunn, JR., West Hills, CA (US); Sevak Samuel Zaribian, Granada Hills, CA (US)

(72) Inventors: Robert Wayne Nunn, JR., West Hills, CA (US); Sevak Samuel Zaribian, Granada Hills, CA (US)

(21) Appl. No.: 13/573,410

(22) Filed: Sep. 14, 2012

(51) Int. Cl. H04W 4/00

(52) U.S. Cl. CPC H04W 4/00
USPC 455/414.1; 709/204

(57) ABSTRACT

Users can reconnect with old friends by using their existing printed physical yearbook. Friends pages are accessed by downloading our mobile app on their smartphone or tablet. Users use our mobile app image scanner similar to the way a QR code is scanned but in our case there is nothing added to the detected senior portrait. It works using an image recognition API.

Claiming the benefit under 35 U.S.C. 119(e) and 37 CFR 1.78 of a prior provisional application filed on Sep. 12, 2011. Application No. 61/573,708

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### STATEMENT OF NO NEW MATTER

The substitute specification contains no new matter.

### BACKGROUND OF THE INVENTION

The present invention provides a system and method which gateways the physical, tangible yearbook to a formatted customizable digital yearbook page by means of the World Wide Web.

Traditional yearbooks are a printed compilation including, but not limited to, photographs, videos, images and descriptions, developed using conventional desktop publishing applications. Often these compilations relate to a particular group of students, military personnel, or divisions within a public or private institution. Traditional yearbooks contain self-portraits of each individual within the particular group of students, military personnel, or other public and private institutions. An element of the traditional yearbook creation is that it is limited in its printed space and reserved in allotted pages. Thus, the traditional yearbook creation lacks to encompass an individual's total experience within its affiliated group.

Through the Digital Yearbook Page system and method, this innovation serves to enhance the traditional physical yearbook whose natural limitation only afford an individual a narrow confines of the two dimensional picture which conventionally provide the person's name and maybe a brief quote. At its current state the traditional yearbook offers users and consumers the narrow confines of a portrait as its only mode of conveying an individual's character, outlook, accomplishment and reflections in his or her role and journey through the institution for which the yearbook was created.

### BRIEF SUMMARY OF THE INVENTION

The present invention is a technological system which links the traditional tangible yearbook to the individual's formatted digital yearbook page, hosted on the World Wide Web, by means of a server. Specifically, the invention improves the printed yearbook in that it provides a platform for individuals to showcase his or her activities, milestones, photographs, writings, awards, connections, contact info, and organize class reunions in detail, which would not be possible in the traditional yearbook given its limited allotted pages.

### BRIEF DESCRIPTION OF FIGURES/DRAWINGS

FIG. 1 is a perspective view of a printed physical yearbook page containing the school portraits images. Users access classmates Digital Yearbook Pages simply by scanning a student's portrait with our mobile app.

FIG. 2 is a perspective view of a printed physical yearbook page student portrait. The arrow indicates the portion of the picture that is decoded to send a user to a unique URL when scanned

FIG. 3 is a perspective view of a printed physical yearbook page containing the school faculty images. Users access their Digital Yearbook Pages simply by scanning a faculty portrait with our mobile app.

FIG. 4 is a perspective view of a yearbook page faculty portrait. The arrow indicates the portion of the picture that is decoded to send a user to a unique URL when scanned

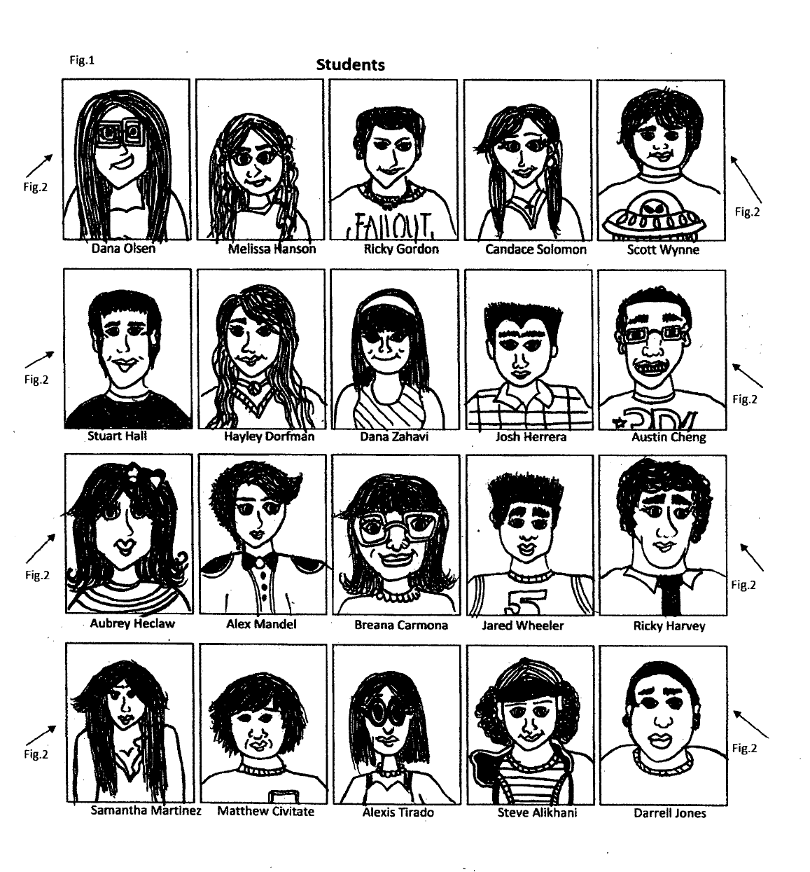

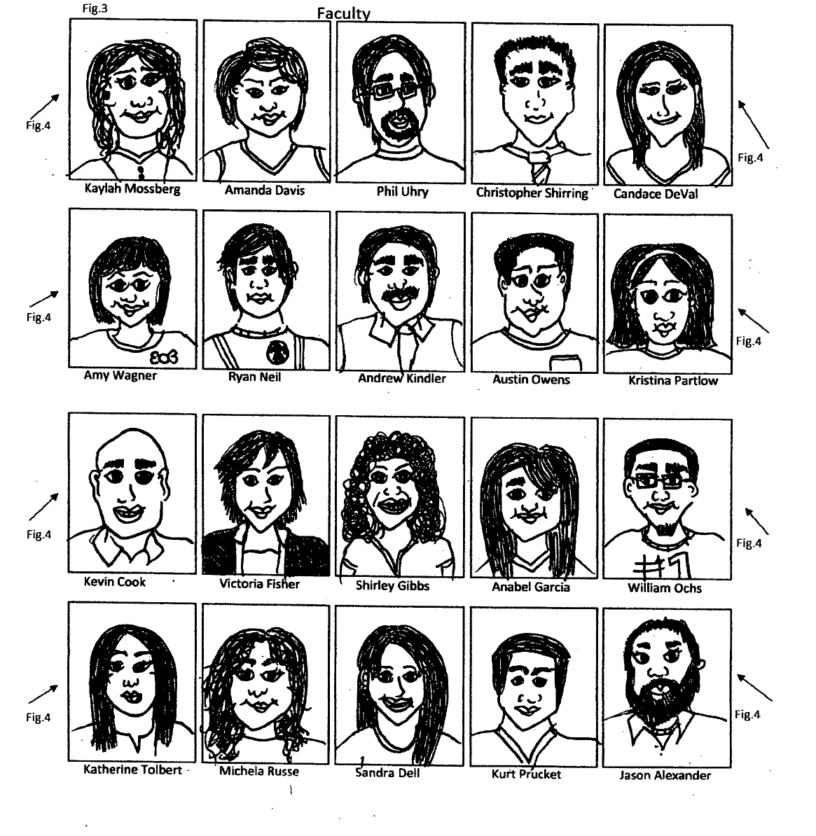

### DETAILED DESCRIPTION OF THE INVENTION

Throughout this description, the term ‘yearbook’ refers to a publication in paper form. This publication usually includes information and images of school classmates during the academic year. This publication specifically includes pictures and images of each student, various activities in the school and various writing.

Throughout this description, the term ‘smart phone’ is used for any phone that operates without a direct wire connection to a phone system by any wireless connection, including all forms of cellular communication, all forms of satellite communication, etc.

Throughout this description, the term ‘personal computer’ indicates any computer device having a user interface for operation by a person.

Throughout this description, the term ‘scan’ indicates any person using a smart phone to decode information from a printed physical page.

Throughout this description, the term ‘Digital Yearbook Page’ refers to the user's randomized URL web page, hosted on a web server. This webpage displays user's submitted written, multimedia and social media URLs.

The company, Digital Yearbook Page Inc., (hereinafter referred to as D.Y.P.) has created a system and method which links the physical, tangible yearbook and an individualized digital yearbook page. The digital yearbook page is formatted so that the individual can log-in, through the use of a smartphone device or personal computer. The digital yearbook page is viewable by means of scanning the individual's portrait with the printed yearbook by using a device capable of recognizing the technology.

The scan process involves utilizing a previously patented method of using a device to capture and process an image, or text, through a computerized memory processor that can identify faces, names, or other pictures through its recognition database and then divert the user to additional information. This information is displayed to a user through a randomized URL hosted on our server that is assigned to the individual's D.Y.P.

The servers also support social network functionality, if the user submits their social network URL into our server. When a yearbook portrait is scanned, the user data is stored and the user scanning the portrait will be able to see information from the user's social networks, known as “social network feed.”

The server has a user authentication file which is used when users create an account.

The servers also support a similar interest search which is called “P.A.L. (Person also likes)” A user who writes any written content on our server is cross checked using a word match algorithm. This allows classmates who also have accounts with D.Y.P. to scan a portrait and view a search result on the randomized URL on our server of the classmate. This page shows a list of every written item the user wrote that the scanned classmate also wrote. The purpose of this is to show what students have in common with each other.

Users may access their Digital Yearbook Page through any other form of physical form of recognition that may be embedded in the tangible medium of the actual physical yearbook that includes and is not limited to any future ventures which may utilize other auditory or tactile recognition; this procedure may include digital devices or

1. A system for providing a digital yearbook comprising:
a server;
a personal computer connected to the server through a network;
a database operationally coupled to the server;
a smart-phone operationally coupled to the server;
a first software module running on the smart-phone provides access to a student's profile page by scanning and recognizing forms of visible or invisible coding and patterns from the physical yearbook;
a second software module running on the server receives yearbook data from the personal computer and the smart-phone through the network and stores the yearbook data in the database;
a third software module running on the personal computer enabling users to view and modify the digital yearbook page.
